(19) United States
(12) Patent Application Publication
(10) Pub. No.: US 2015/0154619 A1
(43) Pub. Date: Jun. 4, 2015

(54) Systems and Methods for Forecasting

(71) Applicant: CATERPILLAR INC., Peoria, IL (US)

(72) Inventors: Anthony James Grichnik, Eureka, IL (US); Christos Nikolopoulos, Peoria, IL (US); Ross Lawrence Fink, Dunlap, IL (US); John Griffith, East Peoria, IL (US); Shashwati Ratnadip Ramteke, Peoria, IL (US); Shua Murtaza, Sugarland, TX (US)

(21) Appl. No.: 14/094,284

(22) Filed: Dec. 2, 2013

(51) Int. Cl. G06Q 30/02

(52) U.S. Cl. CPC G06Q 30/0202

(57) ABSTRACT

A computer-implemented forecasting method is disclosed. The method may include collecting a plurality of historical demand streams. Each historical demand stream may include a time series of historical demand data for a target item at a product distribution node in a supply chain. The method may also include constructing a model tree for the plurality of historical demand streams based on a plurality of forecasting models. The method may further include forecasting a future demand stream of a target item to be distributed by a product distribution node by using a forecasting model that is associated with a specific subgroup that includes a historical demand stream of the target item at the product distribution node.

### TECHNICAL FIELD

This disclosure relates generally to forecasting methods and, more particularly, to forecasting methods for forecasting demand for a target item.

### BACKGROUND

Organizations, such as those that produce, buy, sell, and/or lease products, may desire to forecast information concerning a product. For example, an organization that manufactures one or more products may desire to accurately forecast the demand for the product, the organization's production schedule for the product, and/or a supplier's delivery schedule for subcomponents of the product. Moreover, when developing forecast information for a product, an organization may desire to have the forecast information take into account one or more business goals related to the organization.

U.S. Pat. No. 7,213,007 (the '007 patent) to Grichnik is directed to forecasting characteristics of a product using a genetic algorithm. In particular, the '007 patent discloses a forecasting method including determining one or more equations associated with forecasted characteristics of a target item, implementing a genetic algorithm to determine data values for a plurality of variables in the one or more equations, and forecasting the characteristics of the target item by solving the one or more equations using the determined data values for the variables. While the '007 patent may help to generate statistically accurate representations of the historical data, the forecasts generated by the system of the '007 patent may not always align with a business's goals and strategies.

The disclosed methods and systems are directed to solving one or more of the problems set forth above and/or other problems of the prior art.

### SUMMARY

In one aspect, the present disclosure is directed to a computer-implemented method. The method may include collecting a plurality of historical demand streams. Each historical demand stream may include a time series of historical demand data for a target item at a product distribution node in a supply chain. The method may also include constructing a model tree for the plurality of historical demand streams based on a plurality of forecasting models. The method may further include forecasting a future demand stream of a target item to be distributed by a product distribution node by using a forecasting model that is associated with a specific subgroup that includes a historical demand stream of the target item at the product distribution node.

In another aspect, the present disclosure is directed to a computer-implemented method. The method may include collecting a plurality of historical demand streams. Each historical demand stream may include a time series of historical demand data for a product at a product distribution node in a supply chain over N number of historical time periods, with N being an integer greater than 1. The method may also include identifying a plurality of observation windows within each historical time period, determining, for each one of the 1st to (N−1)th historical time periods, a set of confidence intervals (or “Z scores”) respectively corresponding to the observation windows, and determining a set of average Z scores based on the sets of Z scores determined for the 1st to (N−1)th historical time periods. The method may further include forecasting a future demand stream of a target item to be distributed by a product distribution node over (N+1)th time period by using the sets of average Z scores determined for the 1st to (N−1)th historical time periods, the set of average Z scores, and a historical demand stream of the target item at the product distribution node.

In yet another aspect, the present disclosure is directed to a computer-implemented method. The method may include collecting a plurality of historical demand streams. Each historical demand stream may include a time series of historical demand data for a product at a product distribution node in a supply chain over N number of historical time periods, with N being an integer greater than 1. The method may also include developing a plurality of forecasting models based on the historical demand data over the 1^{st} through (N−1)th historical time periods, and determining, for each one of sub periods in the Nth historical time period, a set of weighting values for the forecasting models by implementing a genetic algorithm. The method may further include forecasting a future demand stream of a target item to be distributed by a product distribution node over (N+1)th time period by using the sets of weighting values and the forecasting models.

### BRIEF DESCRIPTION OF THE DRAWINGS

FIG. 1 is a diagrammatic illustration of an exemplary forecasting system that may be configured to perform certain functions consistent with disclosed embodiments;

FIG. 2 is a flowchart illustrating an exemplary forecasting process consistent with disclosed embodiments;

FIGS. 3A and 3B illustrate a flowchart of a process of constructing a model tree consistent with disclosed embodiments;

FIGS. 4A through 4D illustrate a model tree during a constructing process, consistent with disclosed embodiments;

FIG. 5 is a flowchart illustrating an exemplary forecasting process consistent with disclosed embodiments;

FIG. 6 is a flowchart illustrating an exemplary forecasting process consistent with disclosed embodiments;

FIG. 7 is a flowchart illustrating an exemplary forecasting process consistent with disclosed embodiments;

FIG. 8 is an exemplary table including historical data and calculated data consistent with disclosed embodiments; and

FIG. 9 is an exemplary population table consisting of candidate weighting values consistent with disclosed embodiments.

### DETAILED DESCRIPTION

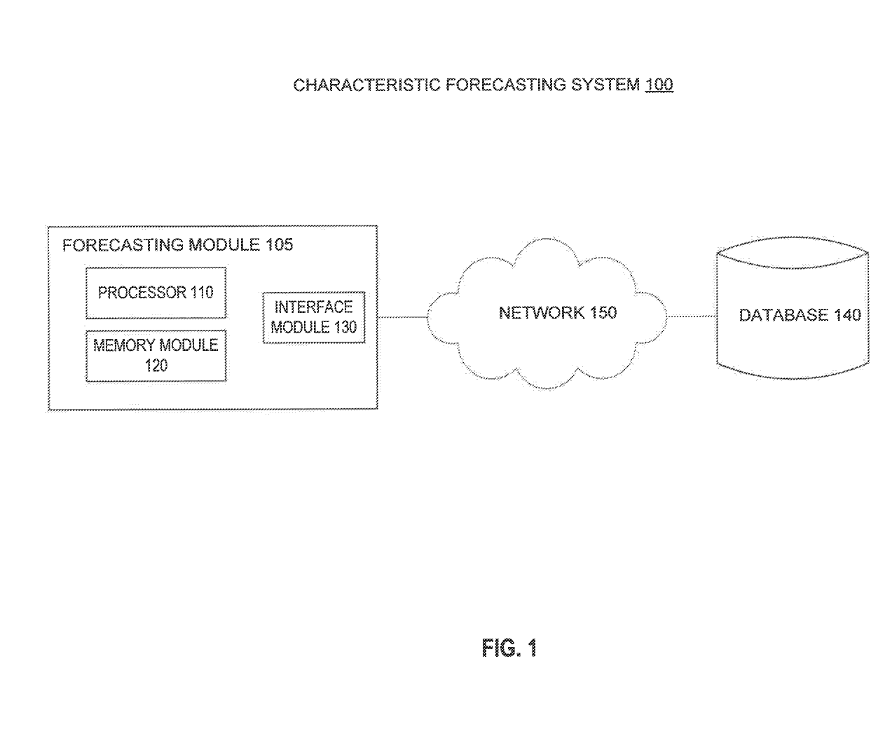

FIG. 1 illustrates an exemplary characteristic forecasting system 100 in which features and principles consistent with disclosed embodiments may be implemented. As shown in FIG. 1 characteristic forecasting system 100 may include a plurality of modules that perform various functions consistent with certain features related to the disclosed embodiments. In one embodiment, characteristic forecasting system 100 may include a forecasting module 105 and a database 140 connected via a network 150.

Forecasting module 105 may be a computing system that performs various functions consistent with certain embodiments. In one embodiment, forecasting module may be configured to forecast the demand for selected products based on historical production activities or other historical data, such as product history data. Forecasting module 105 may include a processor 110, a memory module 120, and an interface module 130. Processor 110 may include one or more processor devices known in the art, such as a microprocessor, microcontroller, laptop computer, desktop computer, workstation, mainframe, etc. Memory module 120 may include one or more storage devices configured to store information that is used by processor 110 and/or other entities internal and external to forecasting module 105. For example, memory module 120 may store one or more characteristic forecast programs that, when executed, enable processor 110 to forecast characteristics (e.g., demand) of a target item (e.g., a product), consistent with disclosed embodiments. Interface module 130 may be one or more devices that facilitate the transfer of information between forecasting module 105 and external components, such as database 140 and/or one or more user devices (not shown).

A product, as used herein, may represent any type of physical good that is designed, developed, manufactured, and/or delivered by a source, such as, for example, a manufacturer or a distributor. The product may also represent replacement parts and/or service parts for existing products, components, or sub-components. Moreover, those skilled in the art will appreciate that a product may represent other types of goods, such as a non-physical object (e.g., stocks, bonds, financial commodities, etc.) that may be generated, obtained, delivered, bought, and/or sold. A target item, as used herein, may represent a tangible object, such as a product. Alternatively, a target item may represent a non-physical product (e.g., stocks, bonds, financial commodities, etc.) or other non-tangible items, such as mathematical representations (e.g., vibration analysis data). Although the forecasting processes discussed below will be described with respect to a product manufactured by a business entity, those skilled in the art will appreciate that the following description may apply to any type of target item.

Database 140 may represent one or more storage devices that store information used by forecasting module 105 to perform certain functions consistent with disclosed embodiments. In one embodiment, database 140 stores product history data. Product history data stored in database 140 may include previous production data for a product, such as a number of products demanded, ordered, sold, manufactured, and/or shipped over a period of time (T) in selected intervals (e.g., days, weeks, months, quarters, years, etc.). Further, the product history data may represent the number of units of the product available during a certain stage of manufacture, such as a molding stage, an engine placement stage, etc. Product history data stored in database 140 may also include historical data regarding components of products, such as data indicating a number of components for a product that have been received from a supplier at selected time intervals. The selected intervals of time t may represent, for example, equal periods of time over which the products are monitored.

Database 140 may also store financial data related to products. For example, database 140 may store information such as demand data for various products at various product distribution centers. Database 140 may also store information such as the sales price per unit, production cost per unit, profit margin per unit, unit carrying cost, etc., related to one or more products. Moreover, database 140 may store information related to inventory levels of one or more products, such as a current inventory level, maximum inventory level, minimum inventory level, etc., of one or more products. Further, database 140 may store any other information that may be used by forecasting module 105 in accordance with one or more of the embodiments discussed below.

Network 150 shown in FIG. 1 may include any one of or combination of wired or wireless networks. For example, network 150 may include wired networks such as twisted pair wire, coaxial cable, optical fiber, and/or a digital network. Likewise, network 150 may include any wireless networks such as RFID, microwave or cellular networks or wireless networks employing, e.g., IEEE 802.11 or Bluetooth protocols. Additionally, network 150 may be integrated into any local area network, wide area network, campus area network, or the Internet.

Although FIG. 1 shows the configuration of processor 110, memory module 120, interface module 130, and database 140 as separate elements, those skilled in the art will appreciate that characteristic forecasting system 100 may be implemented in a number of different configurations consistent with disclosed embodiments. For example, processor 110, memory module 120, interface module 130, and database 140 may be combined into a single module that includes software, hardware, and/or a combination of both. Alternatively, characteristic forecasting system 100 may be configured as a distributed system, with processor 110, memory module 120, interface module 130, and database 140 distributed in remote locations and interconnected by communication paths, such as Local Area Networks (LANs), Wide Area Networks (WANs), and any other type of network that may facilitate communications and the exchange of information between the modules and/or any other elements that may be implemented by characteristic forecasting system 100. Also, characteristic forecasting system 100 may include additional or fewer modules than those depicted in FIG. 1.

In certain embodiments, forecasting module 105 may be an end-user device. In other embodiments, forecasting module 105 and database 140 may be connected to one or more end-user devices (not shown) via network 150. In these embodiments, an end-user at an end-user device may send data, such as product history data, financial data, inventory data, etc., to forecasting module 105 and/or database 140 via network 150. For example, the end-user device may include a web browser and/or other application that enables it to send information to forecasting module 105 and/or database 140 and request forecast data from forecasting module 105. Forecasting module 105 may then determine forecast data based on the data provided by the end-user device, e.g., according to one or more embodiments discussed below, and may then send the forecast data to the end-user device, e.g., via the browser or other application. According to these embodiments, the processing performed by forecasting module 105, according to one or more embodiments discussed below, may be performed “in the cloud” with respect to the end-user, and then the results of the processing (e.g., the forecast data representing a forecast of a Characteristic of a target item) sent back to the end-user. The owner or administrator of forecasting module 105 may charge a fee of some sort to the one or more end-users for using the forecasting services provided by forecasting module 105.

In certain embodiments, exemplary characteristic forecasting system 100 may be configured to develop various forecasting models based on a given set of historical data regarding characteristics of one or more products at different product distribution nodes of a supply chain, and to forecast characteristics of the one or more products at a given time in the future by using the developed forecasting models. The types of the various forecasting models may include a model tree model, a linear regression model, a neural network model, and a bootstrapping model. The neural network model may be a perceptron model, a time series recurrent network model, or an Auto Resonance Theory Mapping (ARTMAP) model.

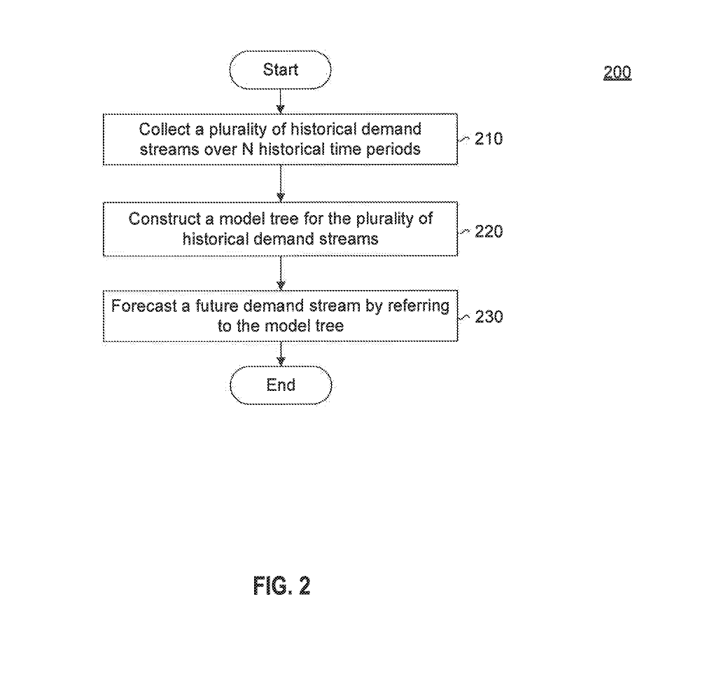

FIG. 2 illustrates a flowchart of an exemplary forecasting process 200 that may be performed by characteristic forecasting system 100 to develop a model tree model and to use the model tree model for forecasting. As illustrated, forecasting module 105 may begin with collecting a plurality of historical demand streams (step 210). Each historical demand stream may include a time series of historical demand data for a product at a product distribution node in a supply chain over a historical time period. In some embodiments, the historical demand data for the same product may be different at different product distribution nodes. Therefore, it is necessary to collect and analyze the historical demand streams for the same product at different product distribution nodes.

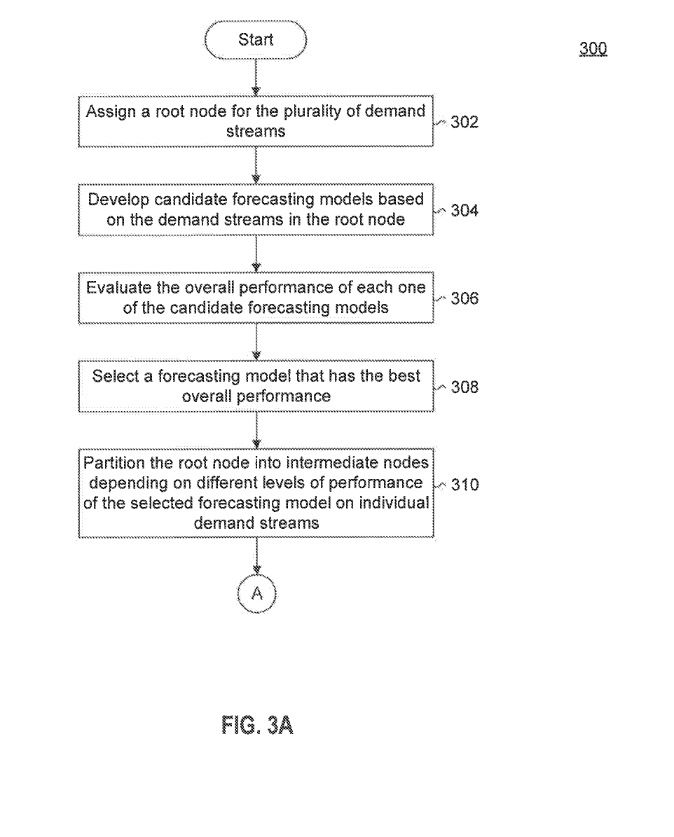

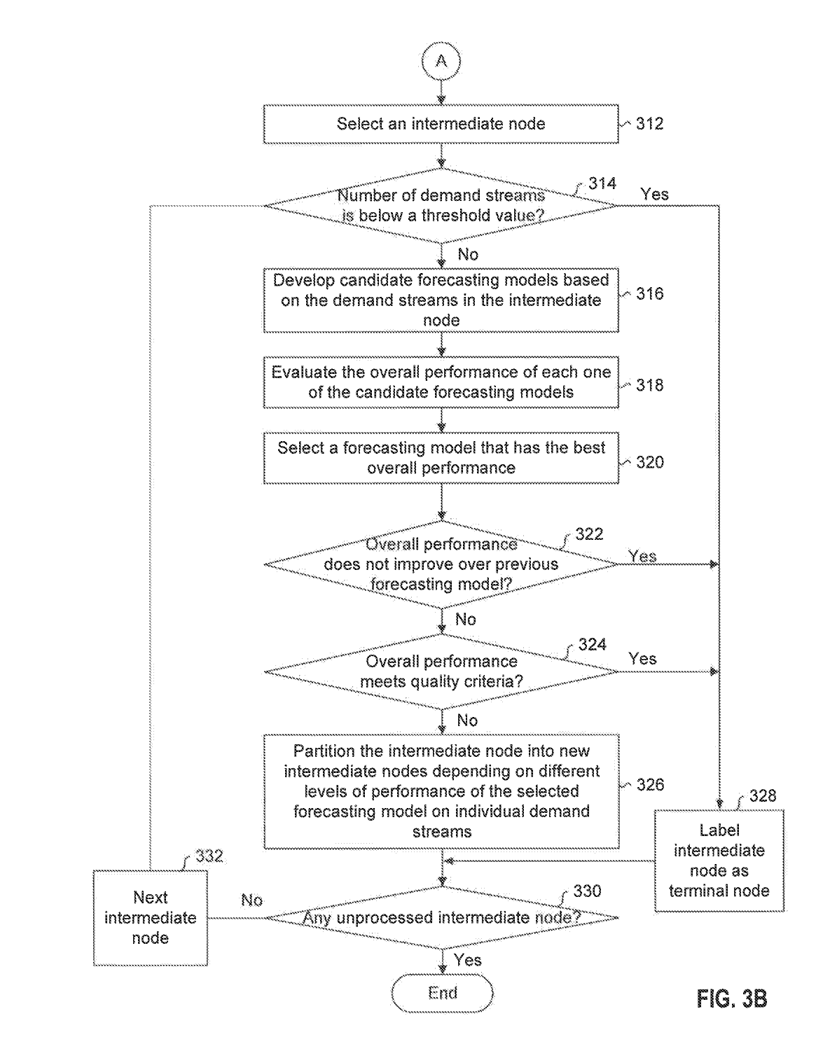

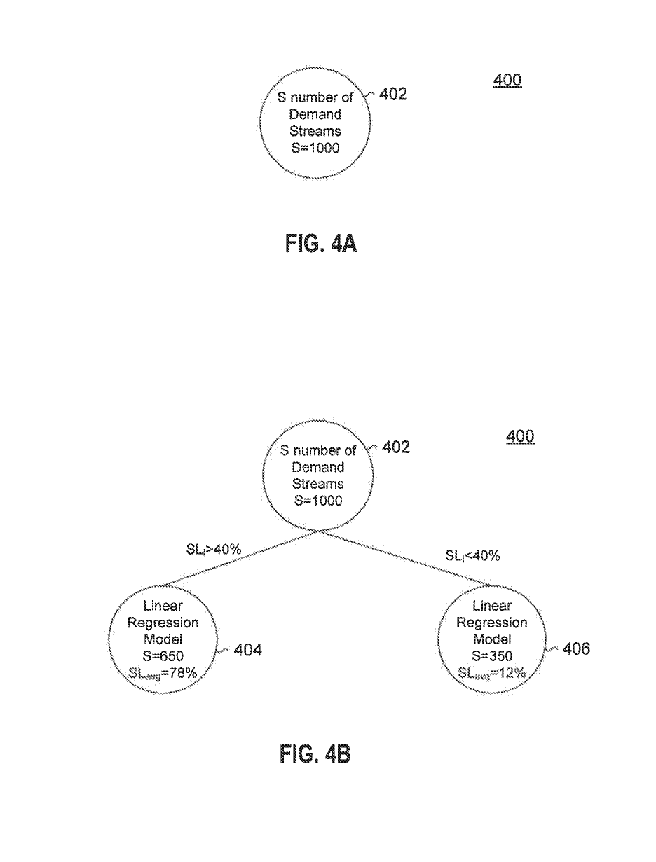

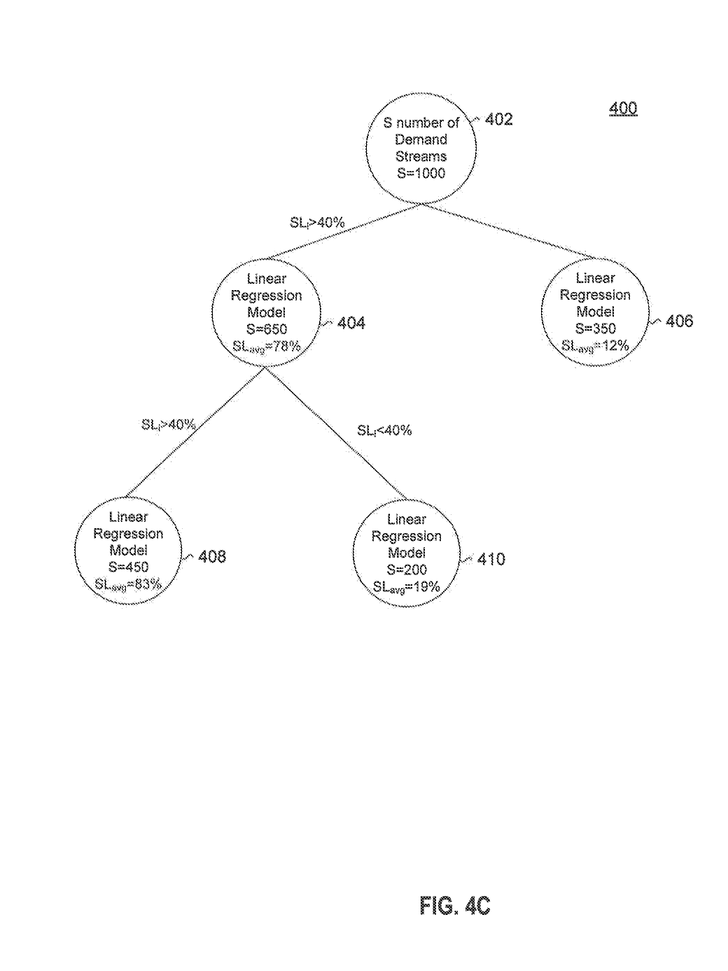

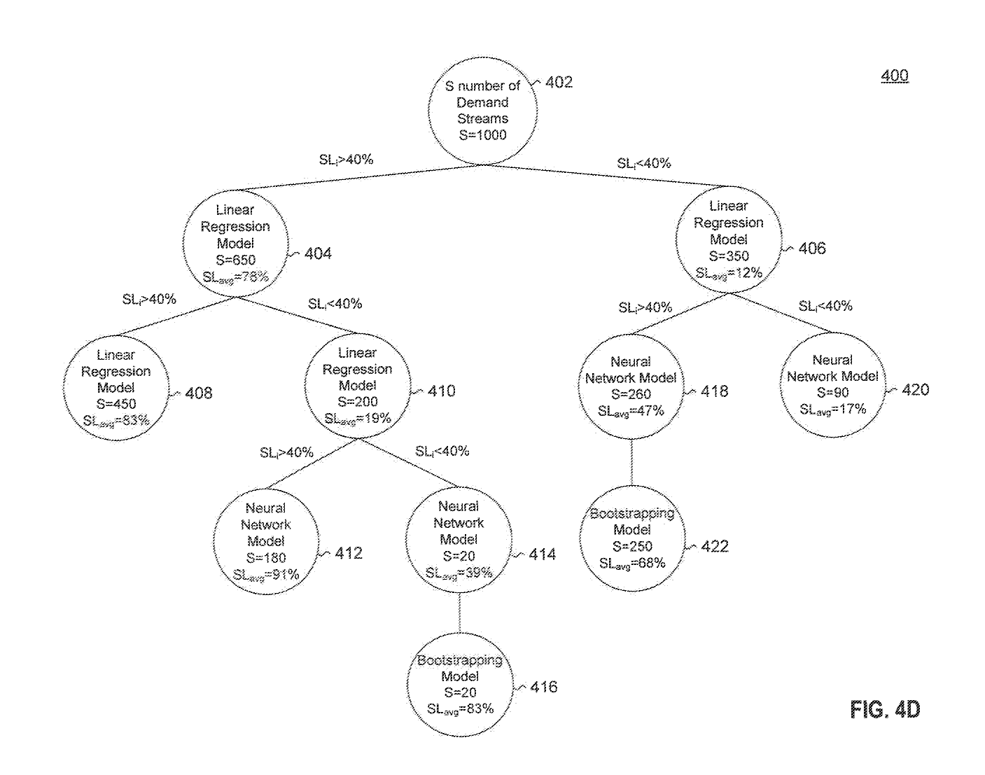

Next, forecasting module 105 may construct a model tree for the plurality of historical demand streams (step 220). The model tree may include a root node, a plurality of intermediate nodes, and a plurality of terminal nodes. The model tree may be branched from the root node through several levels of intermediate nodes to eventually reach a plurality of terminal nodes. Each terminal node may be associated with a subgroup of historical demand streams and a forecasting model that has the best overall performance against one or more business goals on the subgroup of historical demand streams amongst a plurality of forecasting models. In order to determine the best overall performance, forecasting module 105 may evaluate the overall performance of each one of a plurality of candidate forecasting models, and select a forecasting model that produces the best overall performance from among the candidate forecasting models. The one or more business goals may include profit, return on net assets (RONA), inventory turns, service level, or any combination of these business goals. The process of constructing the model tree and determining the best overall performance will be described in detail with reference to FIGS. 3A, 3B, and 4.

Once the model tree is constructed, forecasting module 105 may forecast a future demand stream of a product at a product distribution node by referring to the model tree (step 230). Forecasting module 105 may look for a terminal node in the model tree that is associated with a specific subgroup that includes a historical demand stream that corresponds to the product and the product distribution node. Forecasting module 105 may then retrieve a forecasting model that is associated with the terminal node. Afterwards, forecasting module 105 may use the forecasting model to forecast the future demand stream.

FIGS. 3A and 3B illustrate a flowchart of an exemplary process 300 that may be performed by characteristic forecasting system 100 for constructing a model tree. FIGS. 4A through 4D illustrate an exemplary model tree 400 during a constructing process consistent with disclosed embodiments.

According to process 300, forecasting module 105 may begin with assigning a root node 402 for the plurality of historical demand streams collected in step 210 (step 302). Referring to FIG. 4A, forecasting module 105 may collect S number of historical demand streams, where S=1000. Forecasting module 105 may assign root node 402 to the 1000 historical demand streams.

Then, forecasting module 105 may process root node 402. Specifically, forecasting module 105 may develop a plurality of candidate forecasting models based on the 1000 historical demand streams in root node 402 (step 304). For example, the types of the candidate forecasting models may include a linear regression model, a neural network model, and a bootstrapping model. Forecasting module 105 may develop the candidate forecasting models by determining various variables within each candidate forecasting models. In addition, each one of the historical demand streams may include historical demand data over Year 1 through Year 4. In such case, forecasting module 105 may develop the candidate forecasting models based on the historical demand streams over Year 1 through Year 3 evaluated at appropriate time intervals within this range (e.g. days, weeks, months, or other subdivisions).

Forecasting module 105 may evaluate the overall performance of each one of the candidate forecasting models against one or more business goals (step 306). For example, forecasting module 105 may evaluate the overall performance against service level as the business goal. In such case, forecasting module 105 may calculate a plurality of individual service levels SLᵢ each corresponding to a combination of a historical demand stream and a candidate forecasting model. In order to calculate an individual service level SLᵢ, forecasting module 105 may calculate demands for a product that corresponds to a specific historical demand stream over Year 4 by using a candidate forecasting model, and then calculate the individual service level to be achieved in Year 4 based on the calculated demands. Forecasting module 105 may then calculate, for each candidate forecasting model, an average service level SL_{avg} of the individual service levels SLᵢ corresponding to the candidate forecasting model. As a result, forecasting module 105 may obtain an average service level as the overall performance of each one of the candidate forecasting models. In some embodiments, forecasting module 105 may evaluate the overall performance of each candidate forecasting model based on a difference between actual demands for each product over Year 4 and calculated demands for each product over Year 4 as calculated by using the candidate forecasting model.

After evaluating the overall performance of each one of the candidate forecasting models, forecasting module 105 may select a forecasting model that has the best overall performance to be associated with root node 402 (step 308). Referring to FIG. 4A, forecasting module 105 may select a linear regression model that produces the highest average service level when compared to the other candidate forecasting models. That is, root node 402 is associated with said preferred linear regression model.

Once the linear regression model is selected as the forecasting model associated with root node 402, forecasting module 105 may partition root node 402 into intermediate nodes 404 and 406 depending on different levels of performance of the linear regression model on individual demand streams as illustrated in FIG. 4B (step 310). For example, forecasting module 105 may partition root node 402 depending on the individual service levels SLᵢ calculated by using the linear regression model. Intermediate node 404 includes 650 historical demand streams that produce individual service levels higher than a threshold value, e.g., 40% (SLᵢ>40%). Intermediate node 406 includes 350 historical demand streams that produce individual service levels lower than 40% (SLᵢ<40%). In some embodiments, after pardoning root node 402 into intermediate nodes 404 and 406, forecasting module 105 may calculate an average service level SL_{avg} for each one of intermediate nodes 404 and 406. The average service level SL_{avg} for intermediate node 404 may be an average of the individual service levels SLᵢ of the historical demand streams in intermediate node 404. As a result, intermediate node 404 may have an average service level SL_{avg} of 78%. Similarly, the average service level for intermediate node 406 may be an average of the individual service levels of the historical demand streams in intermediate node 406. As a result, intermediate node 406 may have an average service level SL_{avg} of 12%.

Once root node 402 is partitioned into intermediate nodes 404 and 406, forecasting module 105 may process each one of intermediate nodes 404 and 406 in a manner similar to steps 302 through 310, until a certain stopping criteria is satisfied. To begin with, forecasting module 105 may select one of intermediate nodes 404 and 406 to process (step 312). For example, forecasting module 105 may select intermediate node 404 for the following process steps in FIG. 3B. Forecasting module 105 may then determine if the number of historical demand streams in intermediate node 404 is below a predetermined threshold value (step 314). For example, the predetermined threshold value may be 10% of the number of historical demand streams in root node 402, i.e., 1000. If the number of the historical demand streams in intermediate node 404 is below the predetermined threshold value (step 314, Yes), forecasting module 105 may determine that intermediate node 404 has been processed, and may label intermediate node 404 as a terminal node (step 328). Then, forecasting module 105 may move on to process the next intermediate node, i.e., intermediate node 406. If the number of the historical demand streams in intermediate node 404 exceeds the predetermined threshold value (step 314, No), forecasting module 105 may continue to step 316.

In step 316, forecasting module 105 may develop a plurality of candidate forecasting models based on the historical demand streams in intermediate node 404. For example, intermediate node 404 includes 650 historical demand streams, and therefore forecasting module 105 may develop a plurality of candidate forecasting models based on the 650 historical demand streams over Year 1 through Year 3. The types of the newly developed candidate forecasting models may or may not be the same as the ones previously developed for root node 402. However, in cases where the model type in node 404 is the same as the model type in node 402, the variable values in the candidate forecasting model will be different because node 404 captures a different subsample of the data used in node 402.

Then, forecasting module 105 may evaluate the overall performance of each one of the newly developed candidate forecasting models (step 318). For example, forecasting module 105 may calculate a plurality of individual service levels each corresponding to a combination of a historical demand stream and a newly developed candidate forecasting model. Forecasting module 105 may then calculate, for each newly developed candidate forecasting model, an average service level SL_{avg} as the overall performance of the newly developed candidate forecasting models on intermediate node 404.

After evaluating the overall performance of each one of the newly developed candidate forecasting models, forecasting module 105 may select a forecasting model that has the best overall performance among the newly developed candidate forecasting models (step 320). Referring to FIG. 4B, forecasting module 105 may select a newly developed linear regression model that produces the highest average service level than the other newly developed candidate forecasting models.

Then, forecasting module 105 may determine whether the overall performance of the selected newly developed forecasting model improves over that of the previously developed forecasting model (step 322). For example, forecasting module 105 may compare the average service level of the newly developed linear regression model that is calculated in step 318 with the average service level of the previously developed linear regression model that is calculated in step 310. If the overall performance of the newly developed linear regression model does not improve by more than a specified threshold value (step 322, Yes), forecasting module 105 may determine that intermediate node 404 has been processed, and may label intermediate node 404 as a terminal node (step 328), and move on to the next intermediate node, i.e., intermediate node 406. If the overall performance of the newly developed linear regression model improves over the previously developed linear regression model by more than the threshold value (step 322, No), forecasting module 105 may continue to step 324.

In step 324, forecasting module 105 may determine if the overall performance of the selected newly developed forecasting model meets a certain quality criteria. For example, the quality criteria may be set as a service level of 90%. If the average service level of the newly developed linear regression model exceeds 90% (step 324, Yes), forecasting module 105 may determine that intermediate node 404 has been processed, and may label intermediate node 404 as a terminal node (step 328), and move on to the next intermediate node, i.e., intermediate node 406. If the average service level of the newly developed linear regression model is below 90% (step 324, No), forecasting module 105 may associate the newly developed linear regression model with intermediate node 404, and may continue to step 326.

In step 326, forecasting module 105 may partition intermediate node 404 into intermediate nodes depending on different levels of performance of the selected newly developed forecasting model on individual demand streams, as illustrated in FIG. 4C. Forecasting module 105 may partition intermediate node 404 including the 650 historical demand streams into intermediate nodes 408 and 410 depending on the individual service levels calculated by using the newly developed linear regression model. Intermediate node 408 includes 450 historical demand streams that produce individual service levels higher than 40%. Intermediate node 410 includes 200 historical demand streams that produce individual service levels lower than 40%. In addition, forecasting module 105 may calculate an average service level of the individual service levels produced by the historical demand streams in intermediate node 408 and the newly developed linear regression model. As a result, intermediate node 408 may have an average service level SL_{avg} of 83%. Similarly, intermediate node 410 may have an average service level SL_{avg} of 19%.

Afterwards, forecasting module 105 may determine if there is any unprocessed intermediate node (step 330). For example, forecasting module 105 may determine that intermediate nodes 406, 408, and 410 are unprocessed. In such case (step 330, Yes), forecasting module 105 may select one of intermediate nodes 406, 408, and 410 for processing (step 332). Then, forecasting module 105 may repeat the process for each intermediate node to generate nodes 412 through 422 as illustrated in FIG. 4D. For each one of nodes 408, 416, and 422, forecasting module 105 may determine that the overall performance of a newly developed forecasting model does not improve over the previous one, and may determine to label nodes 408, 416, and 422 as terminal nodes. For node 412, forecasting module 105 may determine that the service level produced by a neural network model developed based on the historical demand streams in node 412 exceeds the threshold value of 90%, and may determine to label node 412 as terminal node 412. For node 420, forecasting module 105 may determine that the number of the historical demand streams included in node 420 falls below the threshold number of 100, and may determine to label node 420 as terminal node 420.

If all of the intermediate nodes have been processed (step 330, No), forecasting module 105 may determine that the construction of model tree 400 has been completed. Then, process 300 may stop.

Although three types of forecasting models were developed in the example of FIG. 4A-4D, it is to be understood that the present disclosure is not limited to those forecasting models, and that various other forecasting models may be developed. In addition, although the root node and the terminal nodes in the example of FIG. 4A-4D are partitioned into two terminal nodes, it is to be understood that the nodes may be partitioned into more than two terminal nodes using different splitting criteria as known in the art.

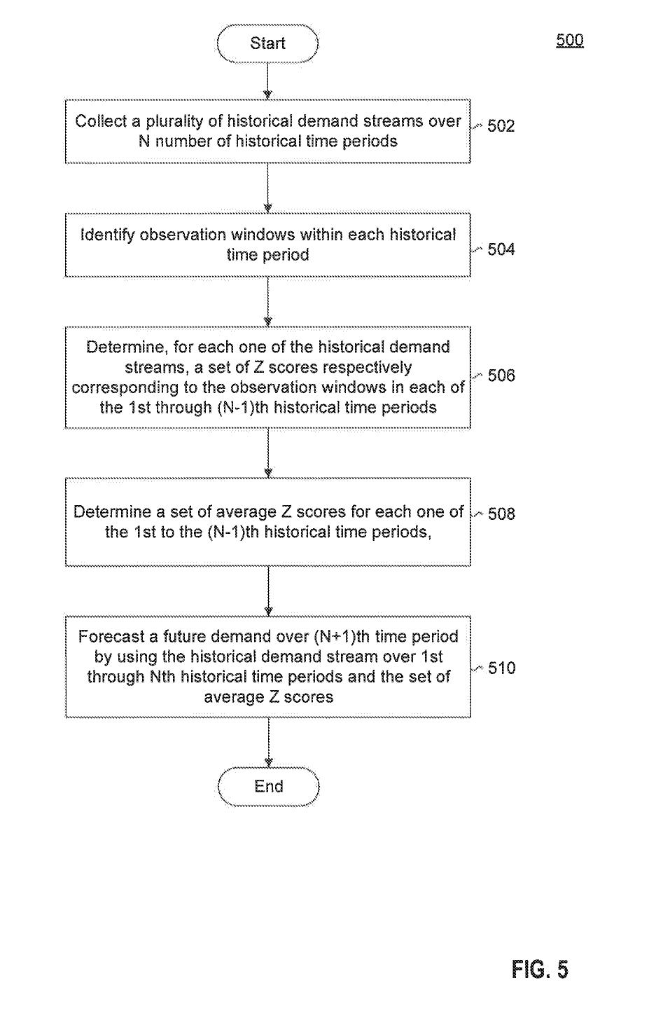

FIG. 5 illustrates a flow chart of an exemplary forecasting process 500 that may be performed by characteristic forecasting system 100 to develop a bootstrapping model and to use the bootstrapping model for forecasting. As illustrated, forecasting module 105 may begin with collecting a plurality of historical demand streams over N number of historical time periods (step 502). Each historical demand stream may include a time series of historical demand data for a product at a product distribution node in a supply chain over the N number of historical time periods. N may be an integer greater than 1. For example, N may be 4; that is, forecasting module 105 may collect a plurality of historical demand streams over Year 1 through Year 4.

Next, forecasting module 105 may identify a plurality of observation windows within each historical time period (step 504). For example, forecasting module 105 may identify four observation windows within each year. The four observation windows may be from January through March, from January through June, from January through September, and from January to December, respectively. In some embodiments, forecasting module 105 may identify the observation windows based on user input, and the user identities the observation windows by inspecting the historical demand streams over N number of historical time period. Alternatively, in some embodiments, forecasting module 105 may identify the observations windows by implementing a genetic algorithm to identify a preferred observation window length and starting time period.

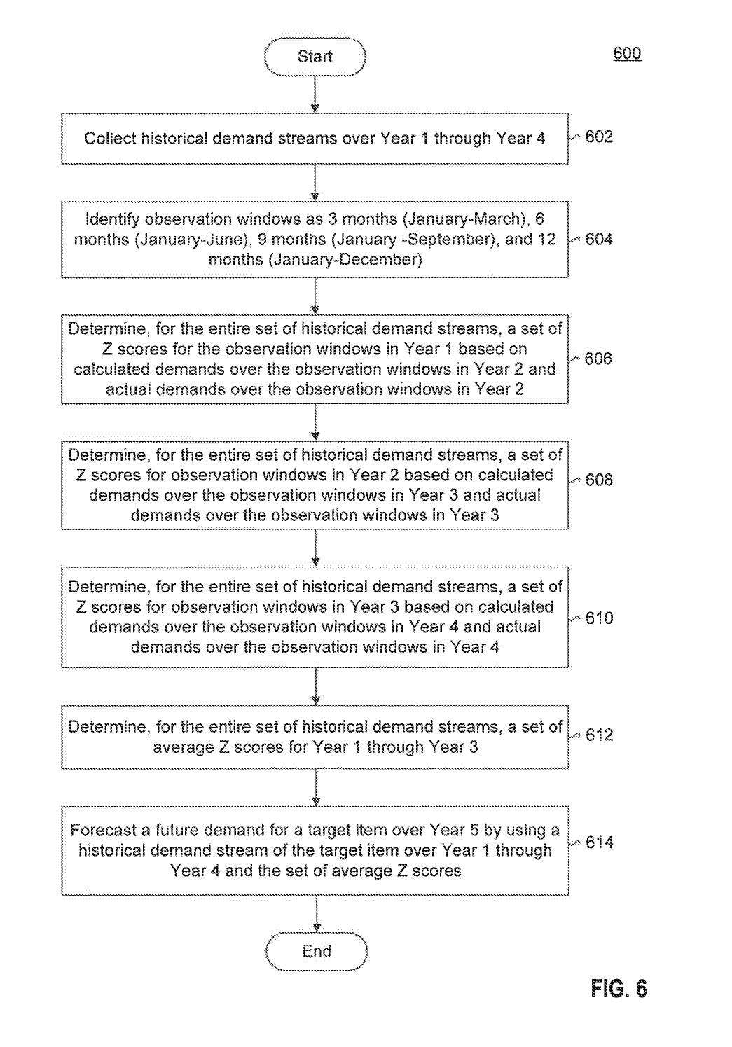

Then, forecasting module 105 may determine, for each combination of a group of historical demand streams and a historical time period, a set of confidence intervals (or “Z scores” as known in the art) respectively corresponding to the observation windows (step 506). For example, forecasting module 105 may determine a set of Z scores for a group of historical demand streams and the (N−1)th historical time period based on sets of Z scores for the 1st through (N−2)th historical time periods. A detailed description of determining the Z scores for each group of historical demand streams will be explained with reference to FIG. 6.

After determining the Z scores, forecasting module 105 may determine a set of average Z scores relevant to a particular observation window (step 508). Forecasting module 105 may calculate, for each observation window, an average Z score by averaging the Z scores of corresponding to the observation window for the 1st through (N−1)th historical time periods.

Finally, forecasting module 105 may forecast a future demand stream of a product at a product distribution node over (N+1)th time period based on the sets of the average Z scores and a historical demand stream of the product at the product distribution node over 1st through Nth historical time periods (step 510). Then, process 500 is completed.

FIG. 6 illustrates a flow chart of an exemplary process 600 of developing a bootstrapping model. In the example of FIG. 6, forecasting module 105 may collect historical demand streams over Year 1 through Year 4 (step 602). Forecasting module 105 may then identify four observation windows including a 3-month long observation window (January-March), a 6-month long observation window (January-June), a 9-month long observation window (January-September), and a 12-month long observation window (January-December) (step 604). The length and beginning time period of each window may be specified by a user, or determined by a genetic algorithm with the goal of maximizing the business goat performance of a collection of historical demand streams.

Forecasting module 105 may then determine, for the entire set of historical demand streams collected in step 602, a set of Z scores for the corresponding observation windows in Year 1 based on calculated demands over the observation windows in Year 2 and actual demands over the observation windows in Year 2 (step 606). For example, forecasting module 105 may first build bootstrapping samples for each one of the observation windows in Year 1. For example, for the 3-month long observation window in Year 1, an i-th historical demand stream may include a data set of (xᵢ(Jan), xᵢ(Feb), xᵢ(Mar)), wherein xᵢ(Jan), xᵢ(Feb), xᵢ(Mar) respectively represent the demand quantities for a corresponding product at a corresponding product distribution center in January, February, and March of Year 1. Forecasting module 105 may build a predetermined number, e.g., 100, of bootstrapping samples by repeatedly sampling with replacement from the data sets of (x₁(Jan), x₁(Feb), x₁(Mar)), through (xₙ(Jan), xₙ(Feb), xₙ(Mar)), where n represents the total number of the historical demand streams collected in step 602. For example, the resamples may include (x₁(Jan), x₁(Jan), x₁(Feb)), (x₁ (Feb), x₁(Jan), x₁(Mar)), (x₁(Mar), x₁(Mar), x₁(Mar)), (x₁(Feb), x₁(Mar), x12), etc., and the equivalent resamples of additional historical demand streams. Forecasting module 105 may then determine a mean M(3-mon,Yr1) and a standard deviation σ(3-mon,Yr1) of the 100 bootstrapping samples built for the 3-month long observation window in Year 1 over the collection of historical demand streams. M(3-mon,Yr1) represents a mean demand for the product over the 3-month long Observation window in Year 1. σ(3-mon,Yr1) represents a standard deviation of the demand for the product over the 3-month long observation window in Year 1. Similarly, forecasting module 105 may determine M(6-mon,Yr1), M(9-mon,Yr1), M(12-mon,Yr1), and σ(6-mon,Yr1), σ(9-mon,Yr1), σ(12-mon,Yr1) of the demand for the product over the 6-, 9-, and 12-month long observation windows in Year 2.

Afterwards, forecasting module 105 may determine the Z scores for Year 1 by implementing a genetic algorithm. Forecasting module 105 may first create a population table consisting of a plurality of sets of candidate Z scores, each set including Z3(Yr1), Z6(Yr1), Z9(Yr1), and Z12(Yr1) respectively corresponds to the 3-, 6-, 9-, and 12-month long observation windows in Year 1. The initial values of the candidate Z scores may be randomly generated. Forecasting module 105 may then calculate demands for the entire set of products over the 3-, 6-, 9-, and 12-month long observation windows in Year 2 by using each set of the candidate Z scores. The calculated demands over the 3-, 6-, 9-, and 12-month long observation windows in Year 2 may be represented by:

Calculated Demand(3-mon,Yr2)=[M(3-mon,Yr1)+Z3(Yr1)*σ(3-mon,Yr1)]*3

Calculated Demand(6-mon,Yr2)=[M(6-mon,Yr1)+Z6(Yr1)*σ(6-mon,Yr1)]*6

Calculated Demand(9-mon,Yr2)=[M(9-mon,Yr1)+Z9(Yr1)*σ(9-mon,Yr1)]*6

Calculated Demand(12-mon,Yr2)=[M(12-mon,Yr1)+Z12(Yr1)*σ(12-mon,Yr1)]*12

Forecasting module 105 may evolve the plurality of sets of candidate Z scores until a convergence criterion is satisfied. The convergence criterion may be satisfied when an improvement of the performance of the candidate Z scores over that of the previous candidate Z scores falls below a threshold, or when the performance of the best set of candidate Z scores meets a certain criterion. Forecasting module 105 may evaluate the performance of each set of the candidate Z scores based on one or more business goal values to be achieved over the observation windows in Year 2 calculated by using the calculated demands over the observation windows in Year 2. When forecasting module 105 determines that the convergence criterion is satisfied, forecasting module 105 may select the best set of Z scores from the sets of candidate Z scores as the Z scores for the observation windows in Year 1. The best set of Z scores may be one that produces the highest fitness value, which may be defined as the most desirable business goal value.

Forecasting module 105 may then determine, for the entire set of historical demand streams, a set of Z scores for the corresponding observation windows in Year 2 based on calculated demands over the observation windows in Year 3 and actual demands over the observation windows in Year 3 (step 608). The calculated demands over the observation windows in Year 3 may be determined as an average of the calculated demands over the corresponding observation windows in Year 1 and Year 2. Therefore, the calculated demands over the 3-months observation window in Year 3 may be represented by:

Calculated Demand(3-mon,Yr3)={[M(3-mon,Yr1)+Z3(Yr1)*σ(3-mon,Yr1)]*3+[M(3-mon,Yr2)+Z3(Yr2)*σ(3-mon,Yr2)]*3}/2

where Z3(Yr1) represents the Z score for the 3-month long observation window in Year 1 that has been determined in step 606; Z3(Yr2) represents the Z score for the 3-month long observation window in Year 2 to be determined; M(3-mon,Yr2) represents a mean demand for the product over the 3-month long observation window in Year 2 and may be determined based on bootstrapping samples built for the 3-month long observation window in Year 2; and σ(3-mon,Yr2) represents a standard deviation of the demand for the product over the 3-month long observation window in Year 2 and may be determined based on the bootstrapping samples built for the 3-month long observation window in Year 2. The calculated demands over the 6-, 9-, and 12-month long observation window in Year 3 may be determined similarly. Forecasting module 105 may then determine the Z scores for the observation windows in Year 2 by implementing the genetic algorithm similar to step 606.

Forecasting module 105 may determine, for the entire set of historical demand streams, a set of Z scores for the corresponding observation windows in Year 3 based on calculated demands over the observation windows in Year 4 and actual demands over the observation windows in Year 4 (step 610). The calculated demands over the observation windows in Year 4 may be determined as an average of the calculated demands over the corresponding observation windows in Year 1, Year 2, and Year 3. Therefore, the calculated demands over the 3-months observation window in Year 3 may be represented by:

Calculated Demand(3-mon,Yr4)={[M(3-mon,Yr1)+Z3(Yr1)*σ(3-mon,Yr1)]*3+[M(3-mon,Yr2)+Z3(Yr2)*σ(3-mon,Yr2)]*3+[M(3-mon,Yr3)+Z3(Yr3)*σ(3-mon,Yr3)]*3}/3

where Z3(Yr1) and Z3(Yr2) represent the Z scores for the 3-month long observation window in Year 1 and Year 2 determined in steps 606 and 608, respectively; Z3(Yr3) represents the Z score for the 3-month long observation window in Year 3 to be determined; M(3-mon,Yr3) represents a mean demand for the product over the 3-month long observation window in Year 3 and may be determined based on bootstrapping samples built for the 3-month long observation window in Year 3; and σ(3-mon,Yr3) represents a standard deviation of the demand for the product over the 3-month long observation window in Year 3 and may be determined based on the bootstrapping samples built for the 3-month long observation window in Year 3. The calculated demands over the 6-, 9-, and 12-month long observation windows in Year 4 may be determined similarly. Forecasting module 105 may then determine the Z scores for the observation windows in Year 3 by implementing the genetic algorithm similar to step 606.

After forecasting module 105 determines the sets of Z scores for each of Year 1 through Year 3, forecasting module 105 may determine a set of average Z scores (step 612). For example, the average Z score Z3avg for the 3-month long observation window may be determined by an average of the Z scores for the 3-month long observation window for Year 1 through Year 3. That is,

Z3avg=[Z3(Yr1)+Z3(Yr2)+Z3(Yr3)]/3

The average Z scores Z6avg, Z9avg, and Z12avg may be determined similarly,

Finally, forecasting module 105 may forecast a future demand for a product over Year 5 over the observation windows in Year 5 based on the set of average Z scores determined for each one of Year 1 through Year 3 and a historical demand stream of the product over Year 1 through Year 4 (step 614). For example, the forecasted future demand over the 3-month observation window in Year 5 may be represented by:

Future Demand(3-mon,Yr5)={[M(3-mon,Yr1)+Z3(Yr1)*(3-mon,Yr1)]*3+[M(3-mon,Yr2)+Z3(Yr2)*σ(3-mon,Yr2)]*3+[M(3-mon,Yr3)+Z3(Yr3)*σ(3-mon,Yr3)]*3+[M(3-mon,Yr4)+Z3avg*σ(3-mon,Yr4)]*3}/4

wherein Z3(Yr1), Z3(Yr2), and Z3(Yr3) represent the scores for the 3-month long observation window in Year 1, Year 2, and Year 3 determined in steps 608 through 610, respectively; M(3-mon,Yr4) represents a mean demand for the product over the 3-month long observation window in Year 4 and may be determined based on bootstrapping samples built for the 3-month long observation window in Year 4; and σ(3-mon,Yr4) represents a standard deviation of the demand for the product over the 3-month long observation window in Year 4 and may be determined based on the bootstrapping samples built for the 3-month long observation window in Year 4.

In the described example, we have used the historic demand periods of Year 1 to Year 4, and broken these into observation windows of useful length. As will be apparent to those skilled in the art, the number of demand periods and observation windows can be tailored to suit the target application as appropriate.

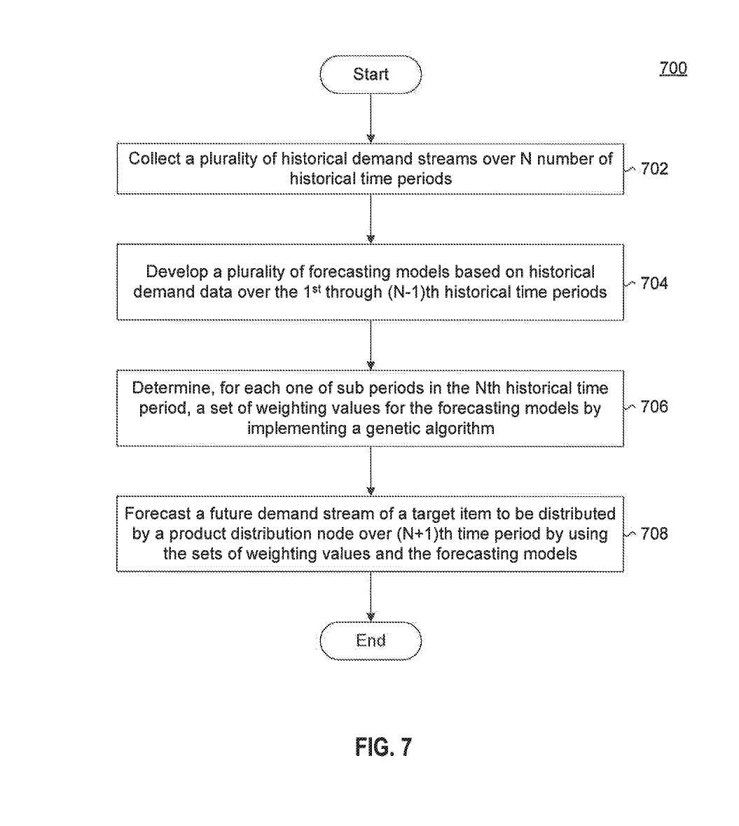

FIG. 7 illustrates a flowchart of an exemplary forecasting process 700 that may be performed by characteristic forecasting system 100 to develop a meta processor model and to use the meta processor model for forecasting. As illustrated, forecasting module 105 may begin with collecting a plurality of historical demand streams over N number of historical time periods (step 702). Each historical demand stream may include a time series of historical demand data for a product at a product distribution node in a supply chain over the N number of historical time periods. N may be an integer greater than 1. For example, N may be 4; that is, the N number of historical time periods may be Year 1 through Year 4.

Next, forecasting module 105 may develop a plurality of forecasting models based on the historical demand streams over the 1st through (N−1)th historical time periods (step 704). For example, forecasting module 105 may develop three forecasting models based on the historical demand data over Year 1 through Year 3. The three forecasting models may include a neural network model, a model tree model, and a bootstrapping model. For example, the model tree model may be the one that is developed with reference to FIG. 2, FIGS. 3A and 3B, and FIGS. 4A-4D. The bootstrapping model may be the one that is developed with reference to FIGS. 5 and 6.

Then, forecasting module 105 may determine, for each one of sub periods in the Nth historical time period, a set of weighting values for the forecasting models by implementing a genetic algorithm (step 706). For example, forecasting module 105 may determine, for each month in Year 4, a set of three weighting values each corresponding to a respective one of the forecasting models. Forecasting module 105 may determine the weighting values based on historical demand data over Year 4 and calculated demand data over Year 4 calculated by using the forecasting models.

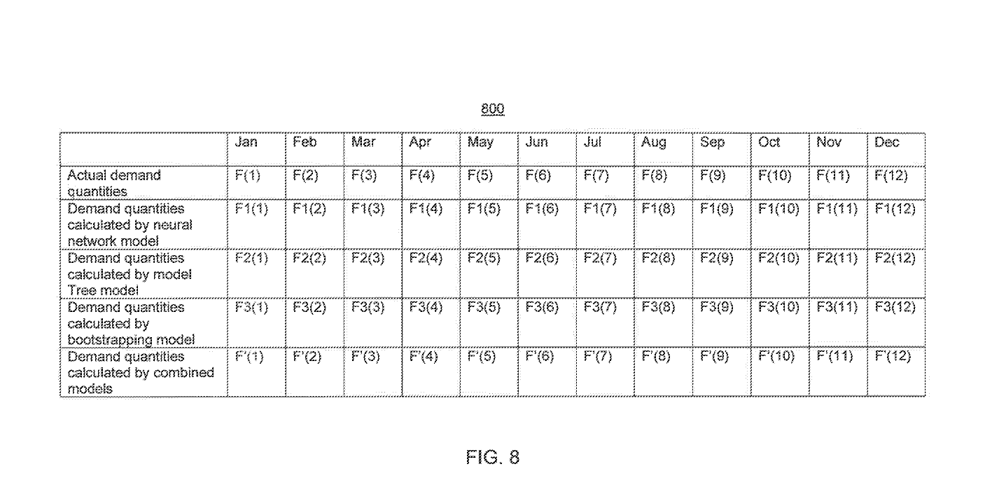

In one exemplary embodiment of determining the weighting values, forecasting module 105 may first calculate demand quantities for a product at a product distribution node over Year 4 by using each one of the plurality of forecasting models. FIG. 8 illustrates an exemplary table 800 including historical demand data and calculated demand data over Year 4. As illustrated, table 800 may include actual demand quantities F(1) through F(12) for January through December of Year 4. The actual demand quantities may be collected by forecasting module 105 in step 702. Table 800 may include demand quantities F1(1) through F1(12) for January through December of Year 4, calculated by using the neural network model that is developed in step 704. Table 800 may also include demand quantities F2(1) through F2(12) for January through December of Year 4, calculated by using the model tree model that is developed in step 704. Table 800 may further include demand quantities F3(1) through F3(12) for January through December of Year 4, calculated by using the bootstrapping model that is developed in step 704.

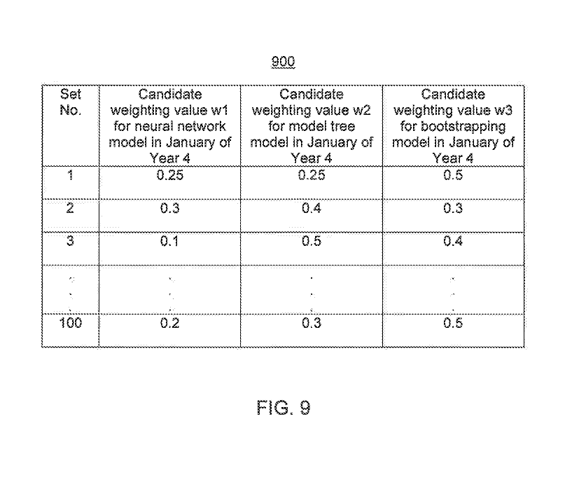

Forecasting module 105 may additionally create, for each one of January through December of Year 4, a population table consisting of a plurality of sets of candidate weighting values for the forecasting models. FIG. 9 illustrates an example population table 900 for January of Year 4. As illustrated, FIG. 9 includes 100 sets of candidate weighting values, and each set includes candidate weighting values w1, w2, and w3 for corresponding ones of the neural network model, the model tree model, and the bootstrapping model.

After creating the population table, forecasting module 105 may calculate a combined demand as a weighted sum for each one of January through December of Year 4, based on each set of the candidate weighting values. As illustrated in FIG. 8, table 800 may include combined demand quantities F′(1) through F′(12) for January through December of Year 4, calculated by a weighted sum of the demand quantities calculated by each of the forecasting model. That is, the demand quantity F′(1) for January of Year 4 may be represented by:

F′(1)=w1×F1(1)+w2×F2(1)+w3×F3(1)

wherein w1 represents the candidate weighting value for the neural network model, w2 represents the candidate weighting value for the model tree model, and w3 represents the candidate weighting value for the bootstrapping model.

Forecasting module 105 may evolve the candidate weighting values in the population table 900 based on the actual demand quantities F1(1) through F1(12) for January through December of Year 4, and the combined demand quantities F′(1) through F′(12) for January through December of Year 4. Forecasting module 105 may also evaluate the performance of each set of candidate weighting values again one or more business goals by calculating one or more business goal values in Year 4 based on the developed forecasting models and the set of candidate weighting values. Forecasting module 105 may complete the evolving of the candidate weighting values once a convergence criterion is satisfied. Then, forecasting module 105 may assert a set of weighting values that has the best performance among the plurality of sets of candidate weighting values in the population table 900.

Referring back to FIG. 7, after determining the set of weighting values for each one of the sub periods in the Nth historical time period, forecasting module 105 may forecast a future demand stream of a product to be distributed by a product distribution node over (N+1)th time period by using the sets of weighting values and the forecasting models (step 708). For example, forecasting module 105 may forecast the further demand stream over Year 5 by using the weighting values and the forecasting models. Then, process 700 may be completed.

While process 700 has been described in terms of weighting 3 model types to produce an aggregated forecast for a collection of historical demand streams, it will be apparent to those skilled in the art that any number of models may be combined in similar fashion.

### INDUSTRIAL APPLICABILITY

Methods, systems, and articles of manufacture consistent with features related to the disclosed embodiments allow a system to forecast values for a product based on historical data associated with the product. These methods and systems may be applied to any tangible and/or non-physical product. In one embodiment, a product may represent a product that is manufactured, delivered, and/or maintained by a business entity, such as a manufacturer. Non-limiting examples of a product may include a vehicle, parts of a vehicle, commercial and/or residential appliances, tools, food service products, and any type of product that may be designed, developed, created, generated, manufactured, delivered, and/or stored as inventory.

Methods and systems consistent with certain embodiments implement a genetic algorithm to evolve a plurality of forecasting equations that may be used to produce forecast data for a product. Moreover, methods and systems consistent with certain embodiments implement the genetic algorithm using a fitness function that takes into account one or more business goals of a business, such as profit, RONA, service level, inventory turns, or other business goals.

It will be apparent to those skilled in the art that various modifications and variations can be made to the disclosed forecasting system. Other embodiments will be apparent to those skilled in the art from consideration of the specification and practice of the disclosed forecasting system. It is intended that the specification and examples be considered as exemplary only, with a true scope being indicated by the following claims and their equivalents.

What is claimed is:

1. A computer-implemented forecasting method, comprising:
collecting, by a processor, a plurality of historical demand streams, each historical demand stream comprising a time series of historical demand data for a target item at a product distribution node in a supply chain;
constructing, by the processor, a model tree for the plurality of historical demand streams based on a plurality of forecasting models; and
forecasting a future demand stream of a target item to be distributed by a product distribution node by using a forecasting model that is associated with a specific subgroup that includes a historical demand stream of the target item at the product distribution node.

2. The method of claim 1, wherein constructing the model tree includes:
(a) developing a plurality of candidate forecasting models based on a subgroup of historical demand streams that is associated with a node of the model tree;
(b) calculating, for each candidate forecasting model, an overall performance value against the one or more business goals on the subgroup of historical demand streams;
(c) selecting a forecasting model that has the best overall performance value amongst the plurality of candidate forecasting models;
(d) associating the selected forecasting model with the node;
(e) calculating, for each historical demand stream within the subgroup of demand streams, an individual performance value of the selected forecasting model;
(f) partitioning the node into new nodes depending on difference levels of the individual performance values of the selected forecasting model; and
(g) repeatedly performing steps (a)-(f) for each node of the model tree until a stopping criteria is satisfied.

3. The method of claim 2, wherein the stopping criteria is at least one of:
the number of historical demand streams associated with a node of the model tree is below a threshold number;
the best overall performance of a forecasting model associated with a node of the model tree does not improve over the best overall performance of a forecasting model associated with a parent node; and
the overall performance of the forecasting model associated with a node of the model tree exceeds a threshold performance value.

4. The method of claim 2, wherein,
the individual performance value of a forecasting model on a historical demand stream is calculated based on one or more business goal values determined by using the selected forecasting model, and
the overall performance value of the forecasting model on the subgroup of historical demand streams is calculated based on an average of the individual performance values of the forecasting model on the subgroup of historical demand streams.

5. The method of claim 1, wherein the forecasting models include at least one of a linear regression model, a neural network model, and a bootstrapping model.

6. A computer-implemented method for forecasting, comprising:
collecting, by a processor, a plurality of historical demand streams, each historical demand stream comprising a time series of historical demand data for a product at a product distribution node in a supply chain over N number of historical time periods, and N being an integer greater than 1;
identifying a plurality of observation windows within each historical time period;
determining, for each one of the 1st to (N−1)th historical time periods, a set of Z scores respectively corresponding to the observation windows;
determining a set of average Z scores based on the sets of Z scores determined for the 1st to (N−1)th historical time periods; and
forecasting a future demand stream of a target item to be distributed by a product distribution node over (N+1)th time period by using the sets of Z scores determined for the 1st to (N−1)th historical time periods, the set of average Z scores, and a historical demand stream of the target item at the product distribution node.

7. The method of claim 6, wherein determining a set of Z scores respectively corresponding to the observation windows in a historical time period includes:
building bootstrapping samples for each one of the observation windows based on the historical demand streams in the historical time period; and
calculating the mean demand and the standard deviation of demand for each one of the observation windows based on the bootstrapping samples.

8. The method of claim 7, further including:
creating a population table consisting of a plurality of sets of candidate Z scores;
evolving the candidate Z scores in the population table by implementing a genetic algorithm, until a convergence criterion is satisfied; and
selecting a set of Z scores that has the best overall performance against one or more business goals among the plurality of sets of candidate Z scores.

9. A computer-implemented method for forecasting, comprising:
collecting, by a processor, a plurality of historical demand streams, each historical demand stream comprising a time series of historical demand data for a target item at a product distribution node in a supply chain over N number of historical time periods, and N being an integer greater than 1;
developing a plurality of forecasting models based on the historical demand data over the 1^{st} through (N−1)th historical time periods;
determining, for each one of sub periods in the Nth historical time period, a set of weighting values for the forecasting models by implementing a genetic algorithm; and
forecasting a future demand stream of a target item to be distributed by a product distribution node over (N+1)th time period by using the sets of weighting values and the forecasting models.

10. The method of claim 9, wherein determining, for each one of sub periods in the Nth historical time period, a set of weighting values for the forecasting models by implementing a genetic algorithm includes:
calculating, for each one of the historical demand streams, demands over the sub periods in the Nth historical time period by using the forecasting models;
creating, for each one of the sub periods, a population table consisting of a plurality of sets of candidate weighting values for the developed forecasting models;
evolving the candidate weighting values by implementing a genetic algorithm based on the historical demands over the Nth historical time period, until a convergence criterion is satisfied;
selecting, for each one of the sub periods, a set of weighting values that has the best overall performance against one or more business goals among the plurality of sets of candidate weighting values.

11. The method of claim 10, wherein the evolving the candidate weighting values includes:
calculating, for each set of candidate weighting values, a weighted sum of the calculated demands over each one of the sub periods in the Nth historical time period.

12. The method of claim 9, wherein the forecasting models include at least one of a linear regression model, a neural network model, a bootstrapping model, and a model tree model.

13. The method of claim 12, wherein the model tree model is developed by:
constructing a model tree for the plurality of historical demand streams based on a plurality of forecasting models.

14. The method of claim 13, further including:
(a) developing a plurality of candidate forecasting models based on a subgroup of historical demand streams that is associated with a node of the model tree;
(b) calculating, for each candidate forecasting model, an overall performance value against the one or more business goals on the subgroup of historical demand streams;
(c) selecting a forecasting model that has the best overall performance value amongst the plurality of candidate forecasting models;
(d) associating the selected forecasting model with the node;
(e) calculating, for each historical demand stream within the subgroup of demand streams, an individual performance value of the selected forecasting model;
(f) partitioning the node into new nodes depending on difference levels of the individual performance values of the selected forecasting model; and
(g) repeatedly performing steps (a)-(f) for each node of the model tree until a stopping criteria is satisfied.

15. The method of claim 14, wherein the stopping criteria is at least one of:
the number of historical demand streams associated with a node of the model tree is below a threshold number;
the best overall performance of a forecasting model associated with a node of the model tree does not improve over the best overall performance of a forecasting model associated with a parent node; and
the overall performance of the forecasting model associated with a node of the model tree exceeds a threshold performance value.

16. The method of claim 14, wherein,
the individual performance value of a forecasting model on a historical demand stream is calculated based on one or more business goal values determined by using the selected forecasting model, and
the overall performance value of the forecasting model on the subgroup of historical demand streams is calculated based on an average of the individual performance values of the forecasting model on the subgroup of historical demand streams.

17. The method of claim 13, wherein the forecasting models include at least one of a linear regression model, a neural network model, and a bootstrapping model.

18. The method of claim 12, wherein the bootstrapping model is developed by:
identifying a plurality of observation windows within each historical time period;
determining, for each one of the 1st to (N−1)th historical time periods, a set of Z scores respectively corresponding to the observation windows; and
determining a set of average Z scores based on the sets of Z scores determined for the 1st to (N−1)th historical time periods.

19. The method of claim 18, determining a set of Z scores respectively corresponding to the observation windows in a historical time period includes:
building bootstrapping samples for each one of the observation windows based on the historical demand streams in the historical time period; and
calculating the mean demand and the standard deviation of demand for each one of the observation windows based on the bootstrapping samples.

20. The method of claim 19, creating a population table consisting of a plurality of sets of candidate Z scores;
evolving the candidate Z scores in the population table by implementing a genetic algorithm, until a convergence criterion is satisfied; and
selecting a set of Z scores that has the best overall performance against one or more business goals among the plurality of sets of candidate Z scores.
